(19) United States
(12) Patent Application Publication
(10) Pub. No.: US 2006/0160645 A1
(43) Pub. Date: Jul. 20, 2006

(54) Tensioner with ratcheting device

(75) Inventors: George L. Markley, Montour Falls, NY (US); Daniel R. Grosskopf, Freeville, NY (US)

Correspondence Address: BORGWARNER INC., 3850 HAMLIN ROAD, AUBURN HILLS, MI, 48326, US

(73) Assignee: BorgWarner Inc., Auburn Hills, MI (US)

(21) Appl. No.: 11/036,424

(22) Filed: Jan. 14, 2005

(51) Int. Cl. F16H 7/08; F16H 7/22

(52) U.S. Cl. 474/109; 474/110

(57) ABSTRACT

A tensioner including a housing having a bore, a hollow piston, a piston spring, a check valve between the source of pressurized fluid and hollow piston, and a pawl plate. The hollow piston is slidably received within the bore of the housing and forms a fluid chamber with the bore. The hollow piston also has a plurality of grooves formed along the outside thereof. The piston spring biases the piston in an outward direction from the bore. The pawl plate has a bottom with a protruding pawl ridge that meshes with the grooves on the piston. The pawl plate is received by the housing and receives a portion of the piston. One side of the pawl plate is biased in the outward direction by a vertical spring or springs and in a lateral direction by a horizontal spring.

### BACKGROUND OF THE INVENTION

1. Field of the Invention

The invention pertains to the field of chain or belt tensioners. More particularly, the invention pertains to a chain or belt tensioner with a ratcheting device.

2. Description of Related Art

In chain and belt tensionsers, pistons are urged from their housings by a spring or spring plus hydraulic pressure. Check valves were added to tensioners between the pressurized fluid source and the fluid chamber formed between the housing and the piston to prevent backflow of the hydraulic fluid out of the fluid chamber. The rate of leakage, of the piston to the bore clearance, allows the retraction of the piston as makeup fluid subsides or ceases. When the rate of leakage increases, the restriction on retraction of the piston softens and when the rate of leakage decreases, the restriction on retraction of the piston stiffens. When chain load spikes or a loss of fluid pressure is present, retraction of the plunger occurs and if the retraction of the plunger is excessive, loss of chain control or other undesirable effects occur. Therefore, limiting the amount of piston retraction is desirable.

A ratchet device that is used to limit the piston retraction must allow the plunger to retract and reduce chain load when fluid pressure is reduced during engine shutdown, but not so much as to leave the chain uncontrolled during engine restart. The retraction of the piston is limited by the amount of backlash added to the ratchet.

One example of a tensioner that uses a ratchet device is shown in prior art FIG. 1. The ratchet tensioner 1 comprises a tensioner housing 7 having a hole 12 for receiving a plunger 8 and a ratchet pawl 17 pivoted by a shaft 16 to the tensioner housing 7 and biased by a ratchet spring 18. The plunger 8 has teeth on one outer side that engage the ratchet pawl 17. The plunger 8 is biased out of the hole 12 to contact the tension lever 10 by fluid in the hollow section 13 and by the plunger spring 14. The tensioner lever 10 pivots on support shaft 9 and has a shoe surface 11 that contacts and applies tension to the slack side of the timing chain 6 wrapped around the camshaft 4 and its sprocket 5 and the crankshaft 2 and its sprocket 3. The plunger's 8 movement in and out of the hole 12 is limited by its teeth and the ratchet pawl 17 that engage them.

Prior art FIG. 2 shows another tensioner that uses a ratchet device. The tensioner includes a housing 116 with a bore 114 for slidably receiving a hollow piston 104 that creates a fluid chamber with the bore 114. A passage in the housing connects the fluid chamber with a pressurized source of fluid. A check valve (not shown) is provided between the pressurized source and the fluid chamber, allowing fluid into the chamber only. The piston 104 is biased by spring 108 in a protruding direction. The piston 104 contains a series of grooves 106 on its outer surface that are engaged by a pair of pawls 110, 112, located opposite each other in vertical slots in the bore 114. The pawls 110, 112 which have flats that aid in providing backlash are held in place by circlips 102. One of the two pawls 110, 112 is located higher up on the bore 114 than the other. As the piston 104 extends it engages one of the pawls 110, 112, and then the other, providing limited retraction of the piston 104.

FIG. 3 shows another prior art example of a tensioner with a ratchet device. The tensioner includes a housing 202 having a bore 204 for receiving the piston 212 and a shoulder bore 210 for receiving shoulder 218. The bore 204 slidably receives piston 212 that creates a fluid chamber 214 with the bore 204. A passage in the housing 202 connects the fluid chamber 214 with a pressurized source of fluid. A check valve 208 is provided between the pressurized source and the fluid chamber 214, allowing fluid into the chamber 214 only. The piston 212 is biased by a spring 206 in a protruding direction. The shoulder 218 is connected to the piston 212 by a cover 216. The shoulder 218 has an external rack of teeth 220 that receive teeth 226 of a pawl 222 biased by a spring 224 to engage the external rack 220. The shoulder 218 and the piston 212 are prevented from protruding too far by a stop 228.

Another example is U.S. Pat. No. 6,120,402. In one embodiment of U.S. Pat. No. 6,102,402, two wedges define an extending member in a groove. A stepped groove holds the extending members. A side piece of the external rack member has a lower end with an upper surface and a lower surface. The lower end travels axially in a groove of the housing. The lower limit on axial movement of the lower end is the surface of the groove. During operation the limited movement of the lower end of the rack member in the groove of the housing enables limited backward movement of the slide and the piston relative to the housing and thus a small amount of backlash.

In an alternative embodiment, the rack member is formed of multiple pieces. Three pieces are assembled and held together by spring, which forms a cylindrical part. The spring and external rack are held together within the tensioner housing by a pin. The piston slides within the bore and the extending member of the rack slides within the grooves formed on the side of the piston. The extending member includes an upper surface and a lower surface. The lower surface connects with the side pieces by an angled portion. During operation backlash of the piston is limited by the space in the grooves formed between the wedges. As the piston is pushed further outward from the housing, the external member slides over the successive wedge or piston rack portion and is then held within the next groove. A stepped groove is formed so that the rack extending member catches in the stepped groove and stops the piston from leaving the tensioner housing.

### SUMMARY OF THE INVENTION

A tensioner including a housing having a bore, a hollow piston, a piston spring, a check valve between the source of pressurized fluid and hollow piston, and a pawl plate. The hollow piston is slidably received within the bore of the housing and forms a fluid chamber with the bore. The hollow piston also has a plurality of grooves formed along the outside thereof. The piston spring biases the piston in an outward direction from the bore. The pawl plate has a bottom with a protruding pawl ridge that meshes with the grooves on the piston. The pawl plate is received by the housing and receives a portion of the piston. One side of the pawl plate is biased in the outward direction by a vertical spring or springs and in a lateral direction by a horizontal spring.

### BRIEF DESCRIPTION OF THE DRAWING

FIG. 1 shows a schematic of a prior art chain tensioner.

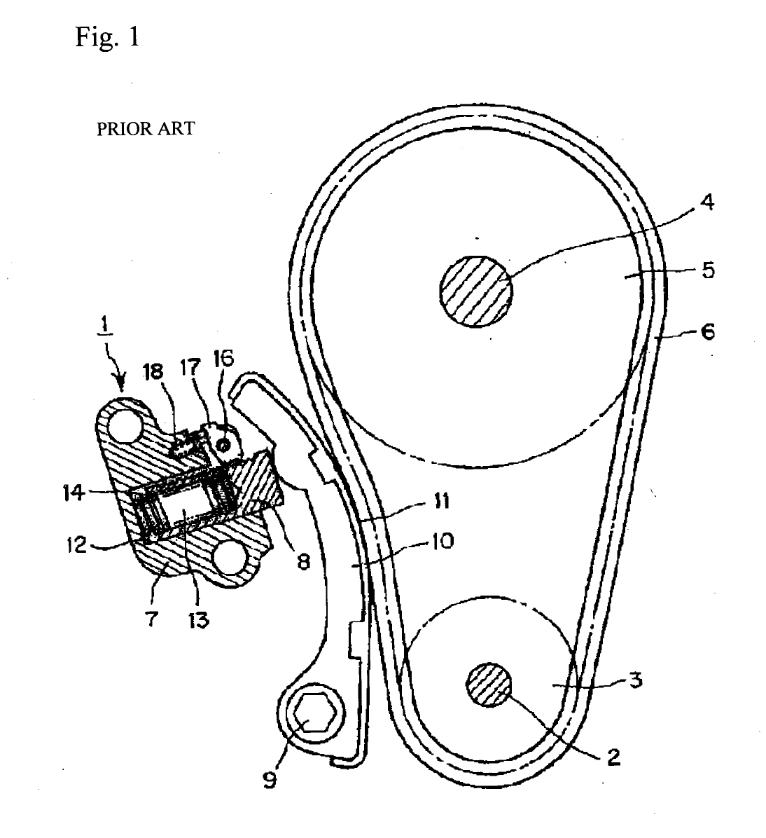

FIG. 2 shows a schematic of a prior art hydraulic tensioner with a pawl-style external rack.

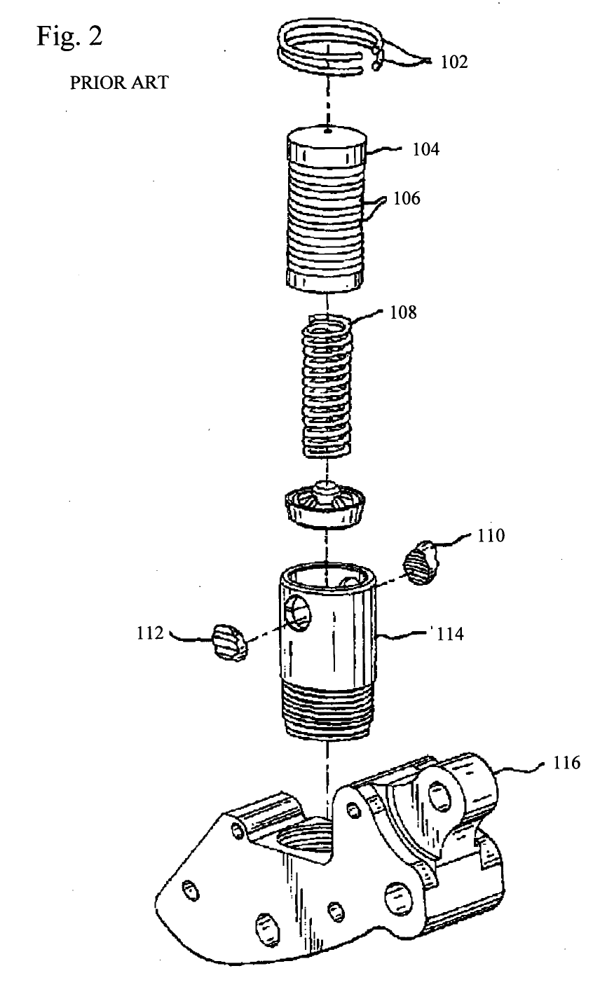

FIG. 3 shows a schematic of a prior art tensioner with a rack attached to the piston shoulder by a cover plate.

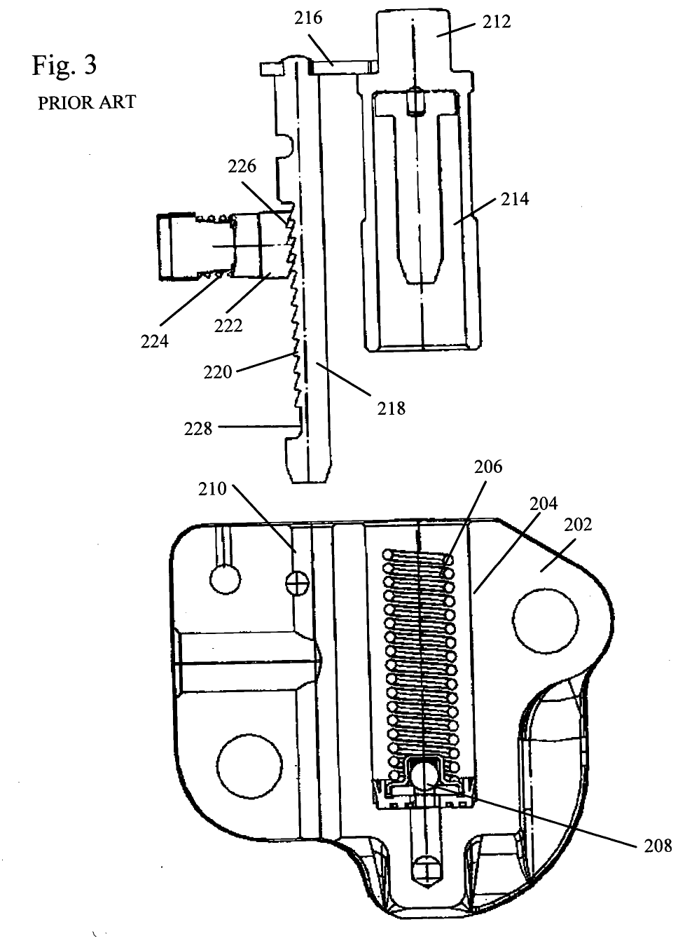

FIG. 4 shows a schematic of the present invention with the piston contained for shipping and installation, with the cover removed to expose the pawl plate.

FIG. 5 shows a section through the piston center along line A-A in FIG. 4.

FIG. 6 shows an exploded view of the pawl plate in mesh with a piston tooth of the piston rack.

FIG. 7 shows an exploded view of the piston extended and the pawl plate about to ratchet the next piston tooth.

FIG. 8 shows an exploded view of the piston extended until stopped by the pawl plate.

FIG. 9 shows a schematic of the piston being reset.

FIG. 10 shows a schematic of the present invention with the piston contained for shipping and installation, with the cover riveted in place.

### DETAILED DESCRIPTION OF THE INVENTION

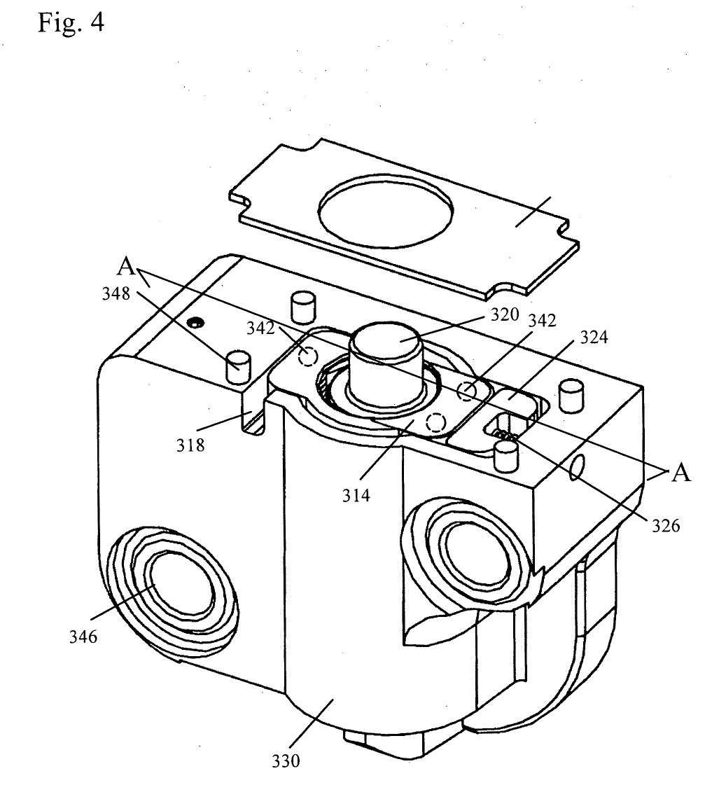

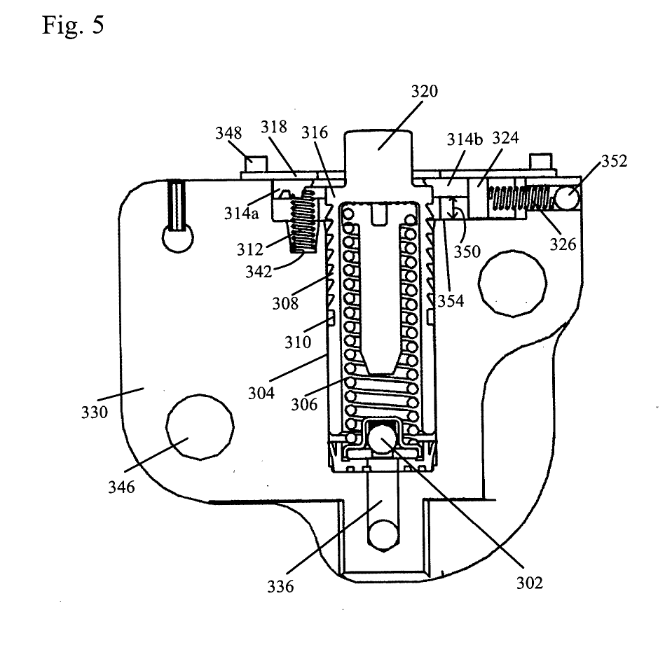

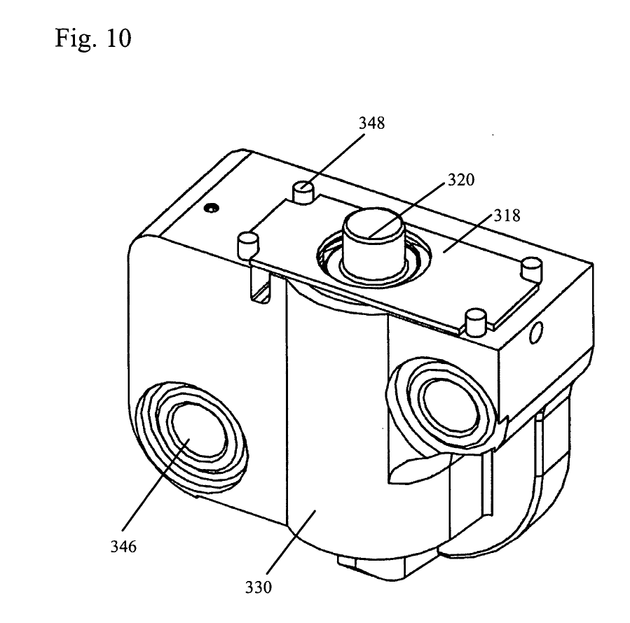

FIGS. 4, 5, and 10 show schematics of the present invention with the piston 320 in a shipping or installation position. The tensioner is attached to the engine block using bolt holes 346 when the piston is in this position.

The tensioner includes a housing 330, which receives a bore 304. The hollow piston 320 is slidably received by bore 304. The bore 304 within the housing 330 forms a fluid chamber (not shown) with the interior of the hollow piston 320. The fluid chamber receives fluid from a pressurized source (not shown) through fluid line 336 and check valve 302. The check valve 302 allows fluid to enter the fluid chamber only. The outside of the hollow piston 320 has a piston shoulder 316 and a series of piston teeth 310 integrally formed on the piston 320, including a stop ring 308. The piston is biased in an outward, extending direction from the housing by spring 306.

A pawl plate 314 is supported on top of the piston shoulders 316 by vertical pawl springs 312 received by holes 342 in the housing. The pawl plate has flat top and a recessed bottom, which has a protruding ridge or pawl that meshes with the piston rack. The vertical pawl spring 312 biases a portion of the pawl plate 314a in a vertical direction against the bottom of the cover plate 318. Another portion of the pawl plate 314b is biased in a horizontal or lateral direction by pawl spring 326 received between body wall 322 of the housing 330 and a retainer 324. The retainer 324 aids in keeping the piston 320 centered in the bore 304 of the housing 330 and preventing the horizontal pawl spring 326 from cocking. The horizontal pawl spring 326 is kept from exiting the housing 330 of the tensioner by a stop or ball 352. The pawl plate 314b engages the shoulder 316 or the piston rack depending on the position of the piston 320. The piston 320 is allowed to retract into the bore 304 a distance equal to the amount of backlash or clearance 350 between the pawl plate 314b and the edge of the bore housing 354. The pawl plate 314 is covered by a cover plate 318 that receives rivets 348 integrally formed on the housing 330.

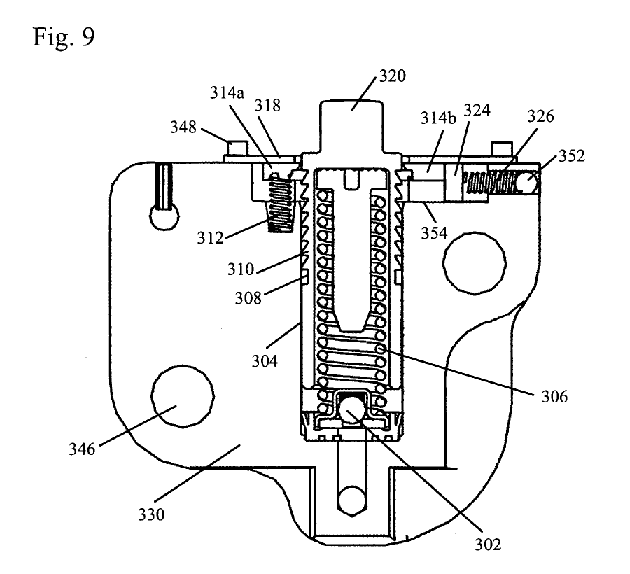

A resetting slot 334 is present adjacent to the vertical pawl spring 312 and pawl plate 314a. A key or screwdriver (not shown) may be inserted into the resetting slot 334 to slide the pawl plate 314 against the retainer 324 and the force of the horizontal spring 326 against the housing wall 332, disengaging the pawl plate 314 from the piston shoulder 316 or the piston rack and allow the piston 320 to center and reset as shown in FIG. 9. The piston 320 may be reset to the shipping/installation position with the pawl in this position at any time.

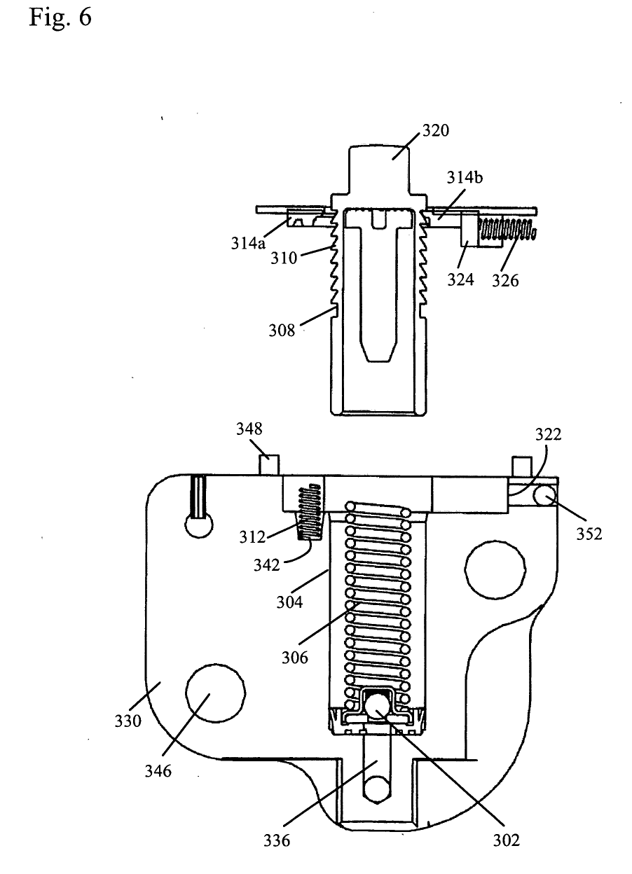

FIG. 6 shows an exploded view of the pawl plate 314b biased by horizontal spring 326 and retainer 324 in contact with a piston tooth 310 of the piston rack as the piston 320 moves from a shipping position to extending outward position with the piston 320 protruding from the housing 330.

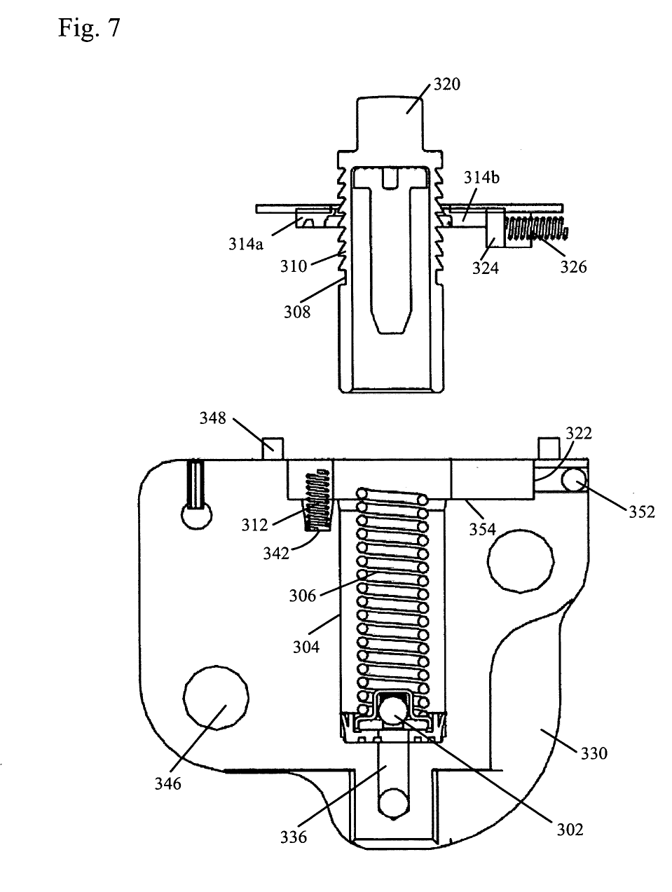

FIG. 7 shows an exploded view of the tensioner with the piston 320 extended outward from the bore 304 to a midway position and pawl plate 314b moving from one ratchet tooth 310 to the next. The pawl plate 314b is biased by the horizontal spring 326 and retainer 324.

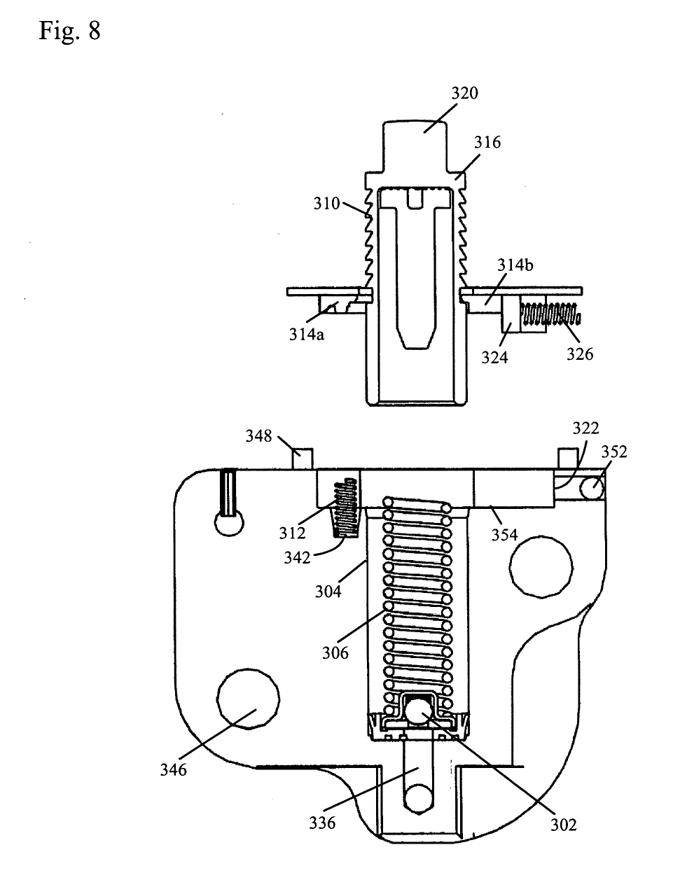

FIG. 8 shows an exploded view of the tensioner in a fully outward extended position. In this position, the pawl plate 314b is engaged with the stop ring 308 of the piston rack. From this position, the tensioner would be reset using resetting slot 334 as described previously.

The vertical pawl springs may be replaced by a conical spring around the piston.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A chain or belt tensioner comprising:
a housing having a bore;
a hollow piston slidably received within the bore, the piston forming a fluid chamber with the bore and having a plurality of grooves formed along the outside of the piston;
a piston spring biasing the piston in an outward direction from the bore;
a check valve provided between the fluid chamber and a pressurized source of fluid to permit fluid into the chamber and prevent flow in a reverse direction; and
a pawl plate having a bottom with a protruding pawl ridge that meshes with the plurality of grooves formed along the outside of the piston received by the housing and for receiving a portion of the hollow piston;
wherein one side of the pawl plate is biased in an outward direction by vertical springs and the other side of the pawl plate is biased in a lateral direction by a horizontal spring.

2. The tensioner of claim 1, wherein the plurality of grooves of the piston includes a stepped groove at a position of maximum outward axial travel of the piston.

3. The tensioner of claim 1, further comprising a retainer piece between the pawl plate and the horizontal spring for providing a sliding surface interfacing with the edge of the pawl plate.

4. The tensioner of claim 1, further comprising a resetting slot adjacent to the side of the pawl plate biased in an outward direction by the vertical springs, wherein when the piston is reset, the pawl plate is biased in the lateral direction against the force of the horizontal spring to disengage the pawl plate from the plurality of grooves formed along the outside of the piston.

5. The tensioner of claim 1, further comprising a cover plate received by the housing.

6. A chain or belt tensioner comprising:
a housing having a bore;
a hollow piston slidably received within the bore, the piston forming a fluid chamber with the bore and having a plurality of grooves formed along the outside of the piston;
a piston spring biasing the piston in an outward direction from the bore;
a check valve provided between the fluid chamber and a pressurized source of fluid to permit fluid into the chamber and prevent flow in a reverse direction; and
a pawl plate having a bottom with a protruding pawl ridge that meshes with the plurality of grooves formed along the outside of the piston received by the housing and for receiving a portion of the hollow piston;
wherein the pawl plate is biased in an outward direction by a conical spring and is biased in a lateral direction by a horizontal spring.

7. The tensioner of claim 6, wherein the plurality of grooves of the piston includes a stepped groove at a position of maximum outward axial travel of the piston.

8. The tensioner of claim 6, further comprising a retainer piece between the pawl plate and the horizontal spring for providing a sliding surface interfacing with the edge of the pawl plate.

9. The tensioner of claim 6, further comprising a resetting slot adjacent to the side of the pawl plate biased in an outward direction by the conical spring, wherein when the piston is reset, the pawl plate is biased in the lateral direction against the force of the horizontal spring to disengage the pawl plate from the plurality of grooves formed along the outside of the piston.

10. The tensioner of claim 6, further comprising a cover plate received by the housing.
